(19) United States
(12) Patent Application Publication
(10) Pub. No.: US 2024/0151079 A1
(43) Pub. Date: May 9, 2024

(54) HANDLE FOR A VEHICLE DOOR

(71) Applicant: MINEBEA ACCESSSOLUTIONS ITALIA S.P.A., Pianezza (IT)

(72) Inventors: Anthony GUERIN, Pianezza (IT); Guillaume DESPREAUX, Pianezza (IT)

(73) Assignee: MINEBEA ACCESSSOLUTIONS ITALIA S.P.A., Pianezza (IT)

(21) Appl. No.: 18/501,628

(22) Filed: Nov. 3, 2023

(30) Foreign Application Priority Data
Nov. 4, 2022 (EP) 22205649.1

(51) Int. Cl. E05B 85/10; E05B 81/76

(52) U.S. Cl. CPC E05B 85/103; E05B 81/76; E05B 85/107

(57) ABSTRACT

A handle for a vehicle door includes a grip member movable between a flush position, an active position and an opening position; a first actuation mechanism including a first return element configured to drive the first actuation mechanism toward a rest position so as to bring the grip member toward the flush position; a second actuation mechanism including a second return element configured to drive the second actuation mechanism so as to bring the grip member toward the flush position. The handle is configured such that a third return element participates in bringing the grip member toward the flush position in case the first return element and second return element are insufficient to bring the grip member toward the flush position.

### CROSS-REFERENCE TO RELATED APPLICATIONS

This application claims priority to and the benefit of EP 22205649.1 filed on Nov. 4, 2022. The disclosure of the above application is incorporated herein by reference.

### FIELD

The present disclosure relates to a handle for a vehicle door including a handle called a flush handle.

### BACKGROUND

The statements in this section merely provide background information related to the present disclosure and may not constitute prior art.

Handles for vehicle doors have a significant influence on the style of vehicles.

In this respect, vehicle manufacturers often seek to arrange the handle in the plane of the door so that it occupies a flush position also called a flush arrangement. A flush handle generally renders the handle as invisible as possible. Such flush door handles also have the advantage of reducing the aerodynamic noise caused by the rush of air as the vehicle is being driven.

A flush handle generally includes an actuator configured to urge a grip member into a deployed position by means of levers so that a user can grasp the grip member and pull the grip member to open the vehicle door.

Such levers generally include a return element having sufficient force to allow the grip member of the handle to return to the flush position.

However, the force is insufficient to allow the retraction of the handle in case where an obstacle, such as ice or dust, has formed between the handle and the door. An obstacle can form if the handle has been deployed for a long time for example.

Furthermore, any increase of the force of the return element would damage the actuator each time it is used to urge the levers to deploy the handle during the deployment cycle.

Document EP3581742 describes the use of a motorized retraction offering a high retraction load to allow the retraction of the handle in the case where an obstacle has formed between the handle and the door. However, the motorized retraction can only be used for few millimeters, otherwise the high retraction load could hurt the user (risk of pinching) if the later does not remove his hand from the handle in time.

The teachings of the present disclosure address these and other issues with typical vehicle door handles.

### SUMMARY

This section provides a general summary of the disclosure and is not a comprehensive disclosure of its full scope or all of its features.

The present disclosure provides a handle for a vehicle door includes a grip member movable between a flush position in which the grip member is configured to extend flush to an external panel of the vehicle door, an active position in which the grip member is configured to project with respect to the external panel of the vehicle door and becomes graspable, and an opening position in which the grip member permits the handle to cooperate with a latch of a vehicle door to unlatch the vehicle door.

The handle includes a first actuation mechanism configured to cooperate with the grip member. The first actuation mechanism includes a first return element configured to drive the first actuation mechanism toward a rest position of the first actuation mechanism to bring the grip member toward the flush position.

The handle includes a second actuation mechanism configured to cooperate with the grip member. The second actuation mechanism includes a second return element configured to drive the second actuation mechanism toward a rest position of the second actuation mechanism to bring the grip member toward the flush position.

The handle includes a third actuation mechanism moveable between an active position in which the third actuation mechanism is configured to cooperate with the first actuation mechanism and to urge the first actuation mechanism toward an active position of the first actuation mechanism, and a rest position in which the third actuation mechanism is configured to release the first actuation mechanism.

The handle includes a force transmitting rod connecting the first actuation mechanism and the second actuation mechanism.

The handle includes a third return element deformable between an initial and a deformed position.

The handle is configured such that the third return element participates in bringing the grip member toward the flush position in case the first return element and second return element are insufficient to bring the grip member toward the flush position.

The handle according to the present disclosure allows the complete retraction of the handle in case where an obstacle has formed between the grip member and the door while avoiding the risk of pinching the user's hand during the return of the handle toward the flush position.

The handle can include the following features, considered alone or in any technically possible combination:
The handle is configured such that the grip member can be brought toward the flush position during a first part of a stroke, via a motorized over-run of the third actuation mechanism from the rest position of the third actuation mechanism and, during a second part of the stroke, via the first, second and third return element.

The third return element is configured to be driven from the initial position toward the deformed position via the motorized over-run of the third actuation mechanism and is configured to return toward the initial position to participate in bringing the grip member toward the flush position.

The handle includes a back-up device connecting the third actuation mechanism to the force transmitting rod, the back-up device including the third return element.

The back-up device includes a linking rod and a sliding element, the sliding element is arranged in the force transmitting rod. The linking rod includes a first end cooperating with the third actuation mechanism and a second end cooperating with the sliding element to drive the sliding element. The sliding element includes the third return element.

The sliding element is at least partially arranged in an aperture chamber. The aperture chamber is arranged in the force transmitting rod. The sliding element is configured to be driven by the second end of the linking rod, so as to slide between a first position wherein the third return element is in the initial position and a second position wherein the third return element is in the deformed position.

The sliding element includes a groove having a first stop, the second end of the linking rod is configured to slide inside the groove. The linking rod is further configured to drive the sliding element toward a first end of the aperture when the second end of the linking rod is in contact with the first stop.

The third return element is arranged at least partially in the aperture chamber.

The third return element is a compression spring.

The handle further includes an obstacle detection system configured to measure whether there is an obstacle inhibiting the grip member from being brought toward the flush position. The obstacle detection system includes a sensor located on the grip member.

When an obstacle is detected, the obstacle detection system controls the third actuation mechanism so that the third return element participates in bringing the grip member toward the flush position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a top view of a handle in an active position according to the present disclosure;

FIG. 2 shows a bottom view of the handle of FIG. 1, illustrating a third actuation mechanism in an active position according to the present disclosure;

FIG. 3 shows a bottom view of the third actuation mechanism of FIG. 2, illustrated in a rest position according to the present disclosure;

FIG. 4 shows a top view of the handle of FIG. 1, illustrating a grip member in an active position according to the present disclosure;

FIG. 5 shows a bottom view of a first part of an over-run of the third actuation mechanism of FIG. 2, illustrated from the rest position according to the present disclosure;

FIG. 6 shows a top view of the handle of FIG. 1, illustrating the grip member in an active position according to the present disclosure;

FIG. 7 shows a bottom view of a second part of the over-run of the third actuation mechanism of FIG. 2 according to the present disclosure;

FIG. 8 shows a top view of the handle of FIG. 1, illustrating the grip member in an active position according to the present disclosure;

FIG. 9 shows a bottom view of the handle of FIG. 1, illustrated in a rest position according to the present disclosure;

FIG. 10 shows a top view of the handle of FIG. 1, illustrating the grip member in a rest position according to the present disclosure;

FIG. 11 shows a top view of the handle of FIG. 1, illustrating the grip member in the opening position according to the present disclosure;

FIG. 12 is a perspective view of the handle of FIG. 1, according to a form of the present disclosure;

FIG. 13 shows a perspective view of a fixation between a first actuation mechanism and the grip member of the handle of FIG. 1 according to a form of the present disclosure;

FIG. 14 shows a perspective view of a fixation between a second actuation mechanism and the grip member of the handle of FIG. 1 according to a form of the present disclosure;

FIG. 15 shows a top view of the handle of FIG. 1 according to a form of the present disclosure;

FIG. 16 shows a top view of the handle of FIG. 1 according to a form of the present disclosure; and

FIG. 17 shows a top view of the handle of FIG. 1 according to a form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A handle 1 for a vehicle door according to the present disclosure is illustrated in FIG. 1.

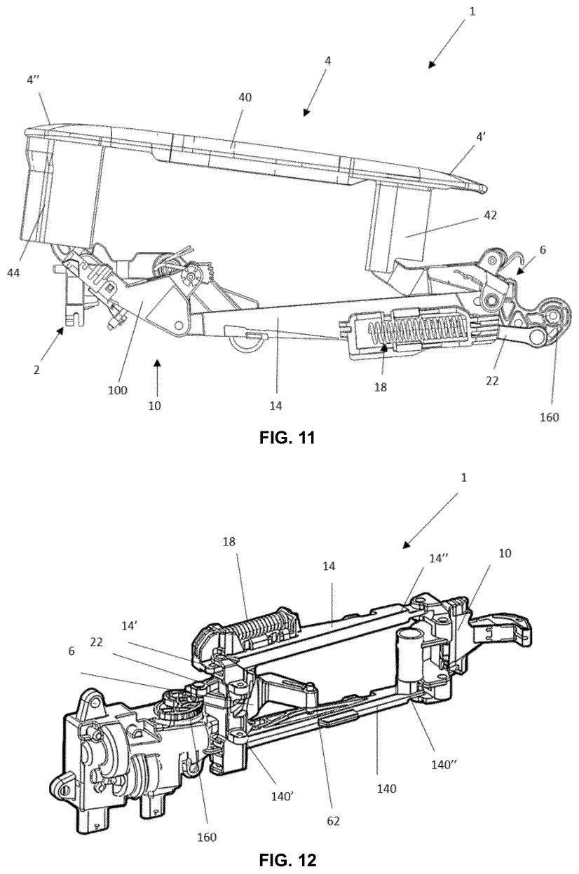

The handle 1 includes a grip member 4 movable between:
a flush position (FIG. 10) in which the grip member 4 extends flush to an external panel of the vehicle door,
an active position (FIG. 1) in which the grip member 4 projects with respect to the external panel “A” of the vehicle door, and
an opening position (FIG. 11) in which the grip member 4 permits the handle 1 to cooperate with a latch lever of the vehicle door to unlatch the vehicle door.

In the flush position (FIG. 10), an external surface 40 of the grip member 4 extends substantially aligned with the external panel “A” represented in dashed line in FIG. 10 of the vehicle door. In the active position (FIG. 1), the grip member 4 becomes graspable, for example by a user's hand. For example, the grip member 4 is movable between the flush position and an active position rage. Active position range means a set of positions wherein the user can grab the grip member 4. Range can mean a set of positions around an outgoing position of the grip member 4 with respect to the external panel “A”. The user can pull on the grip member 4 to drive the grip member from the active position (FIG. 1) toward the opening position (FIG. 11).

In the active position, the external surface 40 of the grip member 4 can extend parallel to the external panel “A” of the vehicle door. For example, the grip member 4 extends parallel with respect to the external panel “A” of the vehicle door when the grip member 4 projects outwardly with respect to the external panel “A” of the vehicle door. For example, the grip member 4 can project from about 5 to 50 millimeters, and in one form 20 to 45 millimeters. For example, 40 millimeters with respect to the external panel “A” of the vehicle door, for example in the active position.

In the opening position (FIG. 11), the grip member 4 permits the handle 1 to cooperate with the latch 2 of the vehicle door so that the user can open the vehicle door. For example, the grip member 4 includes a first end portion 4′ and a second end portion 4″. As used herein, the term “end portion of the grip member” means a portion including an edge of the grip member 4, a free end of the grip member 4. For example, the handle 1 includes a first arm 42 extending from the first end portion 4′ of the grip member 4, for example, perpendicularly with respect to the grip member 4, and a second arm 44 extending from the second end portion 4″ of the grip member 4, for example, perpendicularly with respect to the grip member 4. For example, the first arm 42 and the second arm 44 are fixed to the grip member 4. For example, the first arm 42, the second arm 44 and the grip member 4 are formed in a single piece.

The first arm 42 and the second arm 44 allows, when the grip member 4 is in the active position (FIG. 1), the formation of a recess 200 between the grip member 4 and the external panel “A” of the vehicle door. The recess 200 is intended to receive at least a part of the user's hand so that the grip member 4 becomes graspable by the user's hand.

The door handle assembly 1 can include a first actuation mechanism 6. For example, the first actuation mechanism 6 can cooperates with the first end portion 4′ of the grip member 4. For example, the first actuation mechanism 6 can cooperate with the first end portion 4′ of the grip member 4 through the first arm 42. For example, the first actuation mechanism 6 can be fixed to the first arm 42 of the grip member 4.

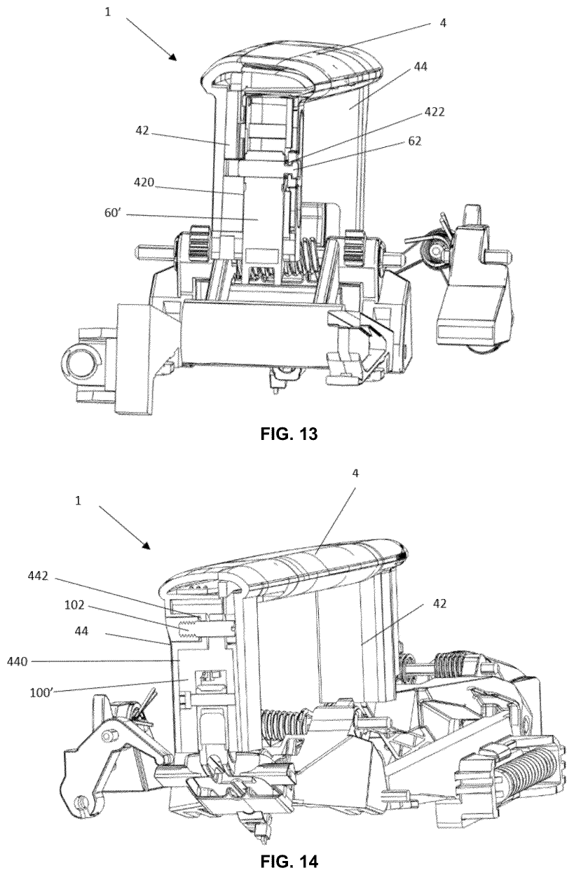

FIG. 13 illustrates a fixation between the first actuation mechanism 6 and the first arm 42 of the grip member 4 according to a form of the present disclosure.

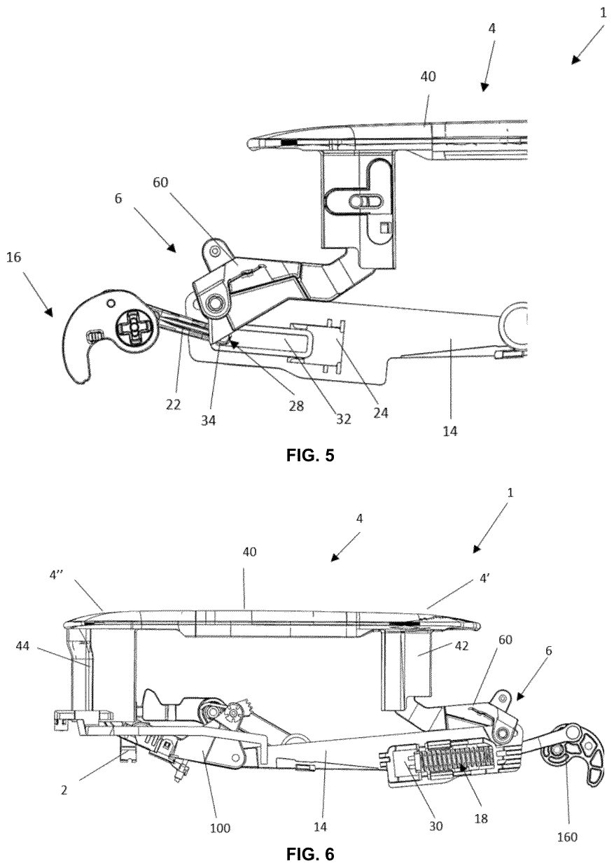

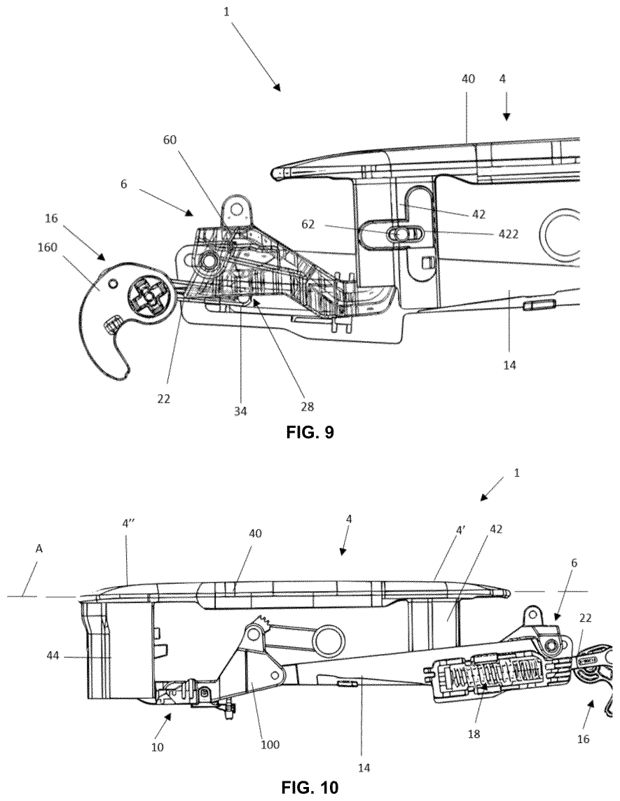

For example, an aperture 420 is arranged within the first arm 42. The aperture 420 is configured to receive a part 60′ of the first actuation mechanism 6. For example, the first actuation mechanism 6 includes a lever 60. For example, a part 60′ of the lever 60 is intended to be received in the aperture 420 of the first arm 42. For example, the handle 1 can include retaining elements 62, 422 configured to secure the first actuation mechanism 6 and the first arm 42 of the grip member 4. For example, the retaining element 62, 422 are configured to secure the part 60′ of the first actuation mechanism 6 in the aperture 420 of the first arm 42 of the grip member 4. For example, the handle 1 includes a rod 62, configured to cooperate with at least one slot 422 (FIGS. 5 and 9) arranged in the first arm 42. For example, the rod 62 is configured to slide within the least one slot 422 arranged in the first arm 42. For example, the lever 60 is configured to cooperate with the rod 62. For example, the lever is configured to cooperate with the rod 62 to be mobile in rotation with respect to the grip member 4.

The rod 62 can have a threaded portion and/or a head. The head can be separated from the rest of the rod 62 by a neck of the rod 62. The head can be out of the slot 422. The neck can be configured to cooperate with a corresponding part of the slot 422 having a reduced width, for instance so as to maintain the rod 62 within the slot. The head and the threaded portion can be located on opposite ends of the rod 62.

The first actuation mechanism 6 is configured to be driven from a rest position (FIG. 10) of the first actuation mechanism 6 to an active position (FIG. 1) of the first actuation mechanism 6 (FIG. 1) to urge the grip member 4 toward the active position of the grip member 4.

The first actuation mechanism 6 is configured to be driven from the active position (FIG. 1) of the first actuation mechanism 6 to the rest position (FIG. 10) of the first actuation mechanism 6 to bring the grip member 4 toward the flush position of the grip member 4. For example, the first actuation mechanism 6 includes a return element 8, called first return element 8, configured to drive the first actuation mechanism 6 from the active position toward the rest position of the first actuation mechanism 6 so that the first actuation mechanism 6 brings the grip member 4 toward the flush position. For example, the return element 8 can includes a spring, for example a torsion spring.

The handle 1 can include a second actuation mechanism 10. For example, the second actuation mechanism 10 can cooperate with the second end portion 4″ of the grip member 4. For example, the second actuation mechanism 10 can cooperate with the second end portion 4″ of the grip member 4 through the second arm 44. For example, the second actuation mechanism 10 can be fixed to the second arm 44.

FIG. 14 illustrates a fixation between the second actuation mechanism 10 and the second arm 44 of the grip member 4 according to a form. For example, an aperture 440 is arranged within the second arm 44. The aperture 440 is configured to receive a part 100′ of the second actuation mechanism 10. For example, the second actuation mechanism 10 includes a lever 100. For example, a part 100′ of the lever 100 is intended to be received in the aperture 440 arranged in the second arm 44 of the grip member 4. For example, the handle 1 can include retaining elements 102, 442 configured to secure the second actuation mechanism 10 and the second arm 44 of the grip member 4.

For example, the handle 1 includes at least one rod 102 configured to cooperate with at least one opening 442 arranged in the second arm 44. For example, the rod 102 is configured to be maintained within the at least one opening 442, for example without sliding. For example, the lever 100 is configured to cooperate with the rod 102. For example, the lever 100 is configured to cooperate with the rod 102 to be mobile in rotation with respect to the grip member 4.

The rod 102 can have a threaded portion. The threaded portion can be located on located at one end of the rod 102. The other end can be neckless.

The second actuation mechanism 10 is configured to be driven from a rest position (FIG. 10) of the second actuation mechanism 10 to an active position (FIG. 1) of the second actuation mechanism 10 to urge the grip member 4 toward the active position of the grip member 4. The second actuation mechanism 10 is also configured to be driven from the active position (FIG. 1) of the second actuation mechanism 10 to the rest position (FIG. 10) of the second actuation mechanism 10 to bring the grip member 4 toward the flush position of the grip member 4. For example, the second actuation mechanism 10 includes a return element 12, called second return element, configured to drive the second actuation mechanism 10 toward the rest position of the second actuation mechanism 10 so that the second actuation mechanism 10 brings the grip member 4 toward the flush position. For example, the second return element 12 can includes a spring, for example a torsion spring.

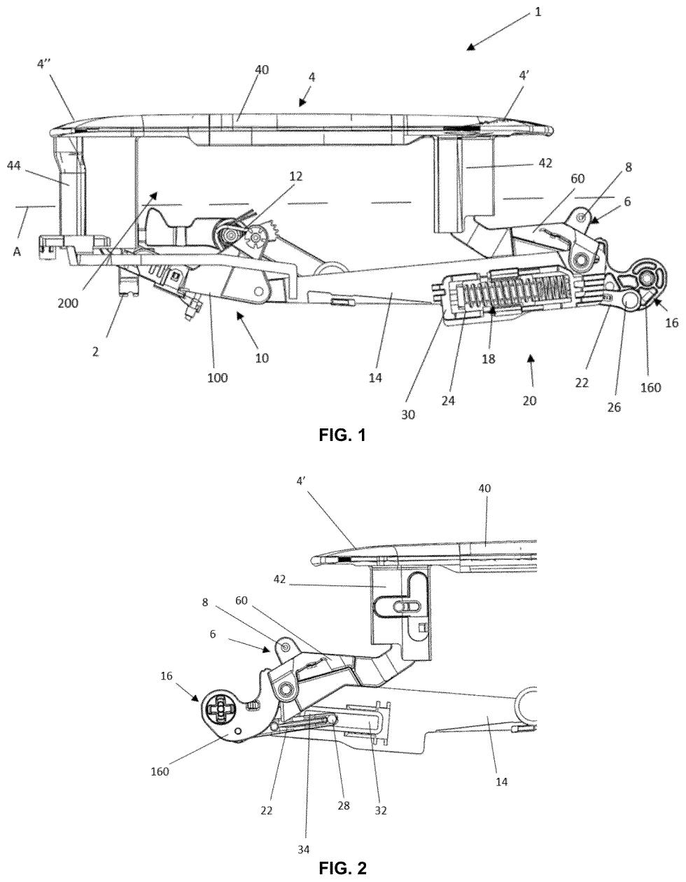

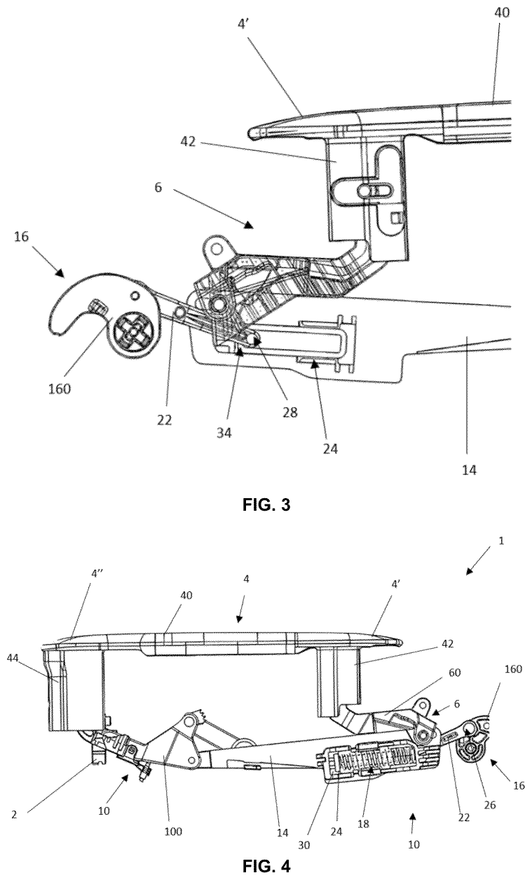

The handle 1 can include a third actuation mechanism 16. The third actuation mechanism 16 is configured to move between an active position (FIG. 1) wherein the third actuation mechanism 16 cooperates with the first actuation mechanism 6 and a rest position (FIG. 3) wherein the third actuation mechanism 16 releases the first actuation mechanism 6. For example, the third actuation mechanism 16 is configured to move from the rest position (FIG. 3) toward the active position (FIG. 1) to urge the first actuation mechanism 6 toward the active position. For example, when the third actuation mechanism 16 moves from the rest position (FIG. 3) toward the active position (FIG. 1), the third actuation mechanism 16 contacts the first actuation mechanism 6 and pushes on the first actuation mechanism 6 (FIG. 2) so as to urge the first actuation mechanism 6 toward the active position. When the first actuation mechanism 6 is urged toward the first actuation mechanism's 6 active position, the first actuation mechanism 6 urges in turn the grip member 4 toward the active position of the grip member 4. For example, when the third actuation mechanism 16 moves from the third actuation mechanism's 16 active position (FIG. 1) toward the third actuation mechanism's 16 rest position (FIG. 3), the third actuation mechanism 16 releases the first actuation mechanism 6 and allows the first actuation mechanism 6 to return to the rest position of the first actuation mechanism 6. For example, when the first actuation mechanism 6 is released from the third actuation mechanism 16, the first actuation mechanism 6 returns in the rest position by means of the return element 8. For example, when the first actuation mechanism 6 returns to the first actuation mechanism's 6 rest position, the first actuation mechanism 6 drives the grip member 4 toward the flush position of the grip member 4.

For example, the third actuation mechanism 16 includes a cam 160. For example, the third actuation mechanism 16 is motorized. For example, the handle 1 includes electrical actuator configured to activate the motorized cam 160.

The handle 1 can include a force transmitting rod 14. For example, the force transmitting rod 14 connects the first actuation mechanism 6 and the second actuation mechanism 10. The force transmitting rod 14 is configured to transmit the movement of the first actuation mechanism 6 to the second actuation mechanism 10.

As illustrated in FIG. 12, the handle 1 can include a first force transmitting rod 14 and a second force transmitting rod 140. For example, the first and second force transmitting rod 14, 140 connect the first actuation mechanism 6 and the second actuation mechanism 10. For example, the first and second force transmitting rod 14, 140 extend parallel to each other. For example, the first force transmitting rod 14 includes a first end portion 14′ fixed to a first side of the first actuation mechanism 6 and a second end portion 14″, opposite to the first end portion 14′, fixed to a first side of the second actuation mechanism 10. For example, the second force transmitting rod 140 includes a first end portion 140′ fixed to a second side of the first actuation mechanism 6 and a second end portion 140″, opposite to the first end portion 140′, fixed to a second side of the second actuation mechanism 10.

In operation, when the third actuation mechanism 16 moves from the third actuation mechanism's 16 rest position toward the third actuation mechanism's 16 active position, the third actuation mechanism 16 cooperates with the first actuation mechanism 6 to urge the first actuation mechanism 6 toward the active position of the first actuation mechanism 6. The displacement of the first actuation mechanism 6 toward the active position of the first actuation mechanism 6 leads to the displacement of the second actuation mechanism 10 toward the active position of the second actuation mechanism, by means of the force transmitting rod 14. When the first actuation mechanism 6 and second actuation mechanism 10 are urged toward their active positions, the first actuation mechanism 6 and the second actuation mechanism 10 in turn, urge the grip member 4 toward the active position of the grip member 4. The grip member 4 become graspable so that the user can pull on the grip member 4 and drive the grip member 4 toward the opening position allowing an opening of the vehicle door. For example, when the grip member 4 is in the grip member's 4 opening position, the second actuation mechanism 10 is configured to contact the latch lever 2 of the vehicle door. For example, when the grip member 4 is urged toward grip member's 4 opening position, the second actuation mechanism 10 is driven to displace the latch lever 2 to unlatch the vehicle door. When the third actuation mechanism 16 moves from third actuation mechanism's 16 active position toward third actuation mechanism's 16 rest position, the third actuation mechanism 16 releases the first actuation mechanism 6 to allow the first actuation mechanism 6 to return to the rest position via the return element 8.

The displacement of the first actuation mechanism 6 toward the rest position of the first actuation mechanism 6 leads to the displacement of the second actuation mechanism 10 toward the rest position of the second actuation mechanism 10, via the force transmitting rod 14. When the first actuation mechanism 6 and second actuation mechanism 10 return to their rest positions, the first actuation mechanism 6 and the second actuation mechanism 10 in turn, drive the grip member 4 toward the flush position of the grip member 4.

If there is an obstacle, for example ice or dust, that has accumulated in the recess 200 between the grip member 4 and the external panel “A” of the grip member 4 when the grip member 4 is in the active position, the return elements 8, 12 of the first actuation mechanism 6 and second actuation mechanism 10 may be insufficient to allow to the grip member 4 to return to the flush position. To this end, the handle 1 can include a third return element 18. The handle 1 is configured such that the third return element 18 participates in bringing the grip member 4 toward the flush position in case the first return element 8 and second return element 12 are insufficient to bring the grip member 4 toward the flush position. For example, the third return element 18 is deformable between an initial position and a deformed position. The handle 1 is configured so that the third return element 18 can be deformed when the first return element 8 and second return element 12 are insufficient to bring the grip member 4 toward the flush position and can participates in bringing the grip member 4 toward the flush position when the third return element 18 returns to third return element's 18 initial position (FIG. 10).

For example, the handle 1 includes a back-up device 20 including the third return element 18. For example, the back-up device 20 connects the third actuation mechanism 16 to the force transmitting rod 14. For example, the back-up device 20 includes a linking rod 22 and a sliding element 24.

For example, the sliding element 24 is arranged in the force transmitting rod 14. For example, the linking rod 22 includes a first end 26 cooperating with the third actuation mechanism 16 and a second end 28 cooperating with the sliding element 24 to drive the sliding element 24. For example, the sliding element 24 includes the third return element 18. For example, the sliding element 24 is at least partially arranged in an aperture chamber 30. For example, the aperture chamber 30 is arranged in the force transmitting rod 14, for example, the first force transmitting rod 14. For example, the sliding element 24 is configured to be driven by the second end 28 of the linking rod 22 to slide between a first position wherein the third return element 18 is in the initial position and a second position wherein the third return element 18 is in the deformed position. For example, in the initial position, the third return element 18 is uncompressed. For example, in the deformed position, the third return element 18 is compressed. For example, the third return element 18 is a spring, for example a compression spring.

For example, the sliding element 24 includes a groove 32 having a first stop 34. For example, the second end 28 of the linking rod 22 is configured to slide inside the groove 32.

For example, the linking rod 22 is further configured to drive the sliding element 24 toward a first end 36 of the aperture 30 when the second end 28 of the linking rod 22 is in contact with the first stop 34. For example, the third return element 18 can be arranged at least partially in the aperture chamber 30. In operation, when the third actuation mechanism 16 moves from third actuation mechanism's 16 active position (FIG. 2) to third actuation mechanism's 16 rest position (FIG. 3), the third actuation mechanism 16 drives the linking rod 22 so that the second end 28 of the linking rod 22 contacts the first stop 34 of the sliding member 24 (FIG. 4). In the third actuation mechanism's 16 rest position, the third actuation mechanism 16 releases the first actuation mechanism 6 (FIG. 3) to allow the grip member 4 to return to grip member's 4 flush position via the first and second return elements 8, 12 of the first and second actuation mechanism 6, 10.

In case the return elements 8, 12 are sufficient, the grip member 4 returns to the grip member's 4 flush position. It is to be understood that the force of the first and second return elements 8, 12 (retraction load) are sufficient to bring the grip member 4 toward the flush position.

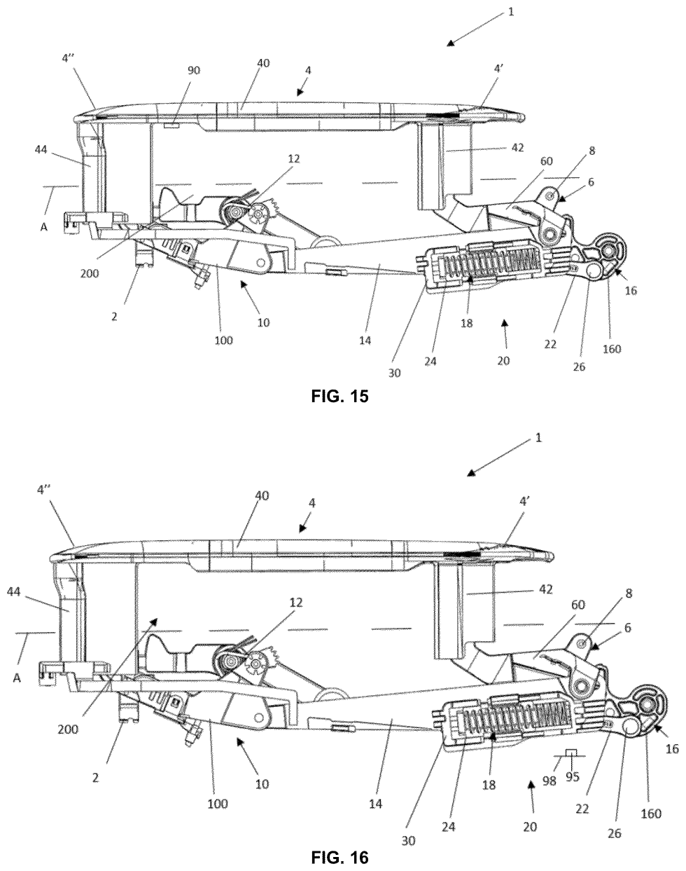

In case the return elements 8, 12 of the first and second actuation mechanism 6, 10 are insufficient to allow to the grip member 4 to return to grip member's 4 flush position, the handle 1 can be configured such that the third return element 18 participates in bringing the grip member 4 toward the flush position. For example, the handle 1 can include an obstacle detection system configured to measure whether there is an obstacle inhibiting the grip member 4 from being brought toward the flush position. For example, when an obstacle is detected, the obstacle detection system controls the third actuation mechanism 16 so that the third return element 18 participates in bringing the grip member 4 toward the flush position. For example, the obstacle detection system includes a sensor 90 located on the grip member 4. For example, the sensor 90 of the grip member 4 is arranged on an internal surface of the grip member 4, for example opposite to the external surface 40 of the grip member 4 (FIG. 15). For example, the internal surface of the grip member 4 is orientated toward the vehicle door when the handle 1 is attached to the vehicle door. Alternatively or additionally, the sensor 90 of the grip member 4 is arranged on the first or second arm 42, 44 of the grip member 4.

Alternatively or additionally, the obstacle detection system includes a sensor 95 of the third actuation mechanism 16. For example, the handle 1 can include a bracket 98 (FIG. 16) and the sensor 95 of the third actuation mechanism 16 is arranged on the bracket 98, near the third actuation mechanism 16. For example, the obstacle detection system can be configured so that an obstacle is detected when the sensor 95 of the third actuation mechanism 16 detects that the third actuation mechanism 16 is in the rest position while the sensor 90 of the grip member 4 detects that the grip member 4 is blocked in the opening position.

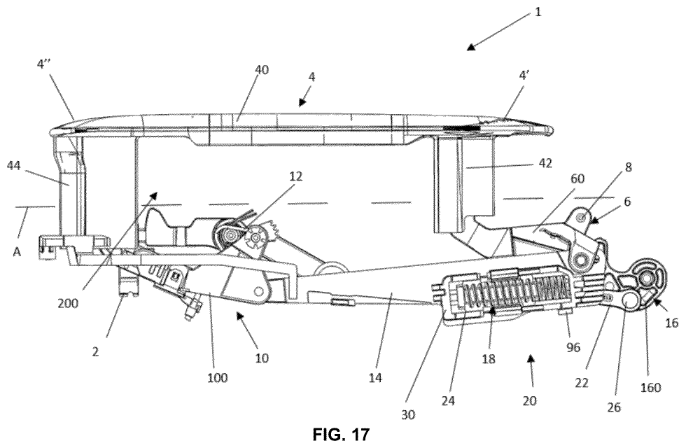

Alternatively or additionally, the obstacle detection system can include a sensor 96 configured to detect the position of the force transmitting rod 14. For example, the sensor 96 is arranged on the force transmitting rod 14. The sensor 96 is configured to detect the position and/or movement of the force transmitting rod 14 that is linked to the grip member 4 (FIG. 17). The sensor 96 can be a Hall sensor. In that case, the obstacle detection system can be configured to control the third actuation mechanism 16, for example by initiating an over-run of the third actuation mechanism 16 during a first part of a stroke.

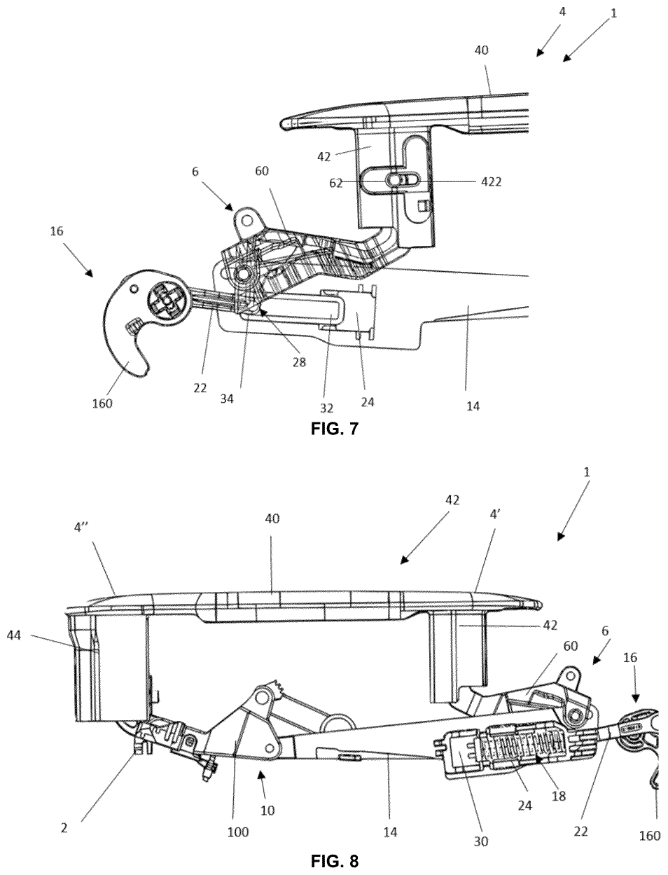

The handle 1 can be configured such that the grip member 4 can be brought toward the flush position during a first part of a stroke, by means of a motorized over-run (FIGS. 5 and 7) of the third actuation mechanism 16 from the rest position (FIG. 3) and during a second part of the stroke, by means of the first, second and third return element 8, 12, 18. For example, the motorized over run of the third actuation mechanism 16 can be divided in two parts. During a first part of the motorized over run (FIG. 5) of the third actuation mechanism 16 (FIG. 5), the third return element 18 is deformed from third return element's 18 initial position (FIG. 4) to third return element's 18 deformed position (FIG. 6). To this end, during the first part of the motorized over run, the third actuation mechanism 16 can pull on the linking rod 22 so that the linking rod 22 drives the sliding element 24 toward the sliding element's 24 second position to deform the third return element 18 (FIG. 6). For example, the linking rod 22 drives the sliding element 24 until the sliding element 24 contacts a first end 36 of the aperture 30.

During a second part of the motorized over run (FIG. 7) of the third actuation mechanism 16, the linking rod 22 is further configured to pull on the force transmitting rod 14, for at least a few millimeters.

The displacement of the force transmitting rod 14 brings the first actuation mechanism 6 and the second actuation mechanism 10 toward their rest positions by a few millimeters, so that the grip member 4 is in turn driven toward the flush position by a few millimeters.

The first part of the stroke of the grip member 4 is motorized. The motorized first part of the stroke offers a sufficient force to allow the grip member 4 to be driven toward the flush position in case there is an obstacle, at least by a few millimeters. For example, the force during the first part of the stroke is between 50 and 200 N, or in one form between 100 and 150 N, or in another form about 50 to 200 N, or in yet another form 100 to 150 N. It is expected that the obstacle is overcome after the first part of the stroke. The first part of the stroke is limited to a few millimeters, for example 5 to 40, or in one form 5 to 10 millimeters, or in another form 8 millimeters.

The handle 1 can be further configured such that the grip member 4 can be brought toward the flush position during a second part of the stroke by means of the first 8, second 12 and third 18 return elements only. The handle 1 is configured so that, at the end of the first part of the stoke, the third return element 18 is configured to return to third return element's 18 initial position to participate in bringing the grip member 4 toward the flush position of the grip member 4. For example, the second part of the stroke of the grip member 4 toward the flush position is mechanical and is achieved due to the first, second and third return elements 8, 12, and 18. For example, the force during the second part of the stroke is less than or equal to 60 N, or in one less than or equal to 50 N. The force of the second part of the stroke corresponds to the total of the force of the first, second and third return elements 8, 12, and 18. The third return element 18 offers a sufficient force during the second part of the stroke to allow the complete return of the handle 1 toward the flush position while avoiding the risk of pinching the user's hand during the return of the grip member 4 toward the flush position.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handle for a vehicle door, the handle comprising:
a grip member movable between:
a flush position in which the grip member is configured to extend flush to an external panel of the vehicle door,
an active position in which the grip member is configured to project with respect to the external panel of the vehicle door and becomes graspable, and
an opening position in which the grip member is configured to permit the handle to cooperate with a latch of a vehicle door to unlatch the vehicle door;
a first actuation mechanism configured to cooperate with the grip member, the first actuation mechanism comprising a first return element configured to drive the first actuation mechanism toward a rest position of the first actuation mechanism so as to bring the grip member toward the flush position;
a second actuation mechanism configured to cooperate with the grip member, the second actuation mechanism comprising a second return element configured to drive the second actuation mechanism toward a rest position of the second actuation mechanism so as to bring the grip member toward the flush position; and
a third actuation mechanism moveable between:
an active position in which the third actuation mechanism is configured to cooperate with the first actuation mechanism and to urge the first actuation mechanism toward an active position of the first actuation mechanism, and
a rest position in which the third actuation mechanism is configured to release the first actuation mechanism;
a force transmitting rod connecting the first actuation mechanism and the second actuation mechanism; and
a third return element deformable between an initial position and a deformed position,
wherein the handle is configured such that the third return element participates in bringing the grip member toward the flush position in case the first return element and second return element are insufficient to bring the grip member toward the flush position.

2. The handle according to claim 1 wherein the handle is configured such that the grip member can be brought toward the flush position:
during a first part of a stroke, by a motorized over-run of the third actuation mechanism from the rest position of the third actuation mechanism, and
during a second part of the stroke, by the first return element, second return element and third return element.

3. The handle according to claim 2, wherein the third return element is configured to be driven from the initial position toward the deformed position by the motorized over-run of the third actuation mechanism and is configured to return toward the initial position so as to participate in bringing the grip member toward the flush position.

4. The handle according to claim 1, wherein the handle comprises a back-up device connecting the third actuation mechanism to the force transmitting rod, the back-up device comprising the third return element.

5. The handle according to claim 4, wherein the back-up device comprises a linking rod and a sliding element, the sliding element is arranged in the force transmitting rod, the linking rod comprising a first end cooperating with the third actuation mechanism and a second end cooperating with the sliding element so as to drive the sliding element, the sliding element comprising the third return element.

6. The handle according to claim 5, wherein the sliding element is at least partially arranged in an aperture chamber, the aperture chamber is arranged in the force transmitting rod, the sliding element is configured to be driven by the second end of the linking rod, so as to slide between a first position wherein the third return element is in the initial position and a second position wherein the third return is in the deformed position.

7. The handle according to claim 6, wherein the sliding element comprises a groove having a first stop, the second end of the linking rod is configured to slide inside the groove, the linking rod is further configured to drive the sliding element toward a first end of the aperture when the second end of the linking rod is in contact with the first stop.

8. The handle according to claim 7, wherein the third return element is arranged at least partially in the aperture chamber.

9. The handle according to claim 1, wherein the third return element is a compression spring.

10. The handle according to claim 1, wherein the handle further comprises an obstacle detection system configured to measure whether there is an obstacle inhibiting the grip member from being brought toward the flush position, the obstacle detection system comprising a sensor located on the grip member.

11. The handle according to claim 10, wherein, when an obstacle is detected, the obstacle detection system controls the third actuation mechanism so that the third return element participates in bringing the grip member toward the flush position.
